(19) United States
(12) Patent Application Publication
(10) Pub. No.: US 2026/0245804 A1
(43) Pub. Date: Aug. 20, 2026

(54) ELECTRONIC COMPONENT AND MODULE

(71) Applicant: TDK Corporation, Tokyo (JP)

(72) Inventors: Masahiro HIRAOKA, Tokyo (JP); Hitoshi SAITA, Tokyo (JP); Yuuki ABURAKAWA, Tokyo (JP)

(73) Assignee: TDK Corporation, Tokyo (JP)

(21) Appl. No.: 19/539,140

(22) Filed: Feb. 13, 2026

(30) Foreign Application Priority Data
Feb. 20, 2025 (JP) 2025-025761

(51) Int. Cl. H01G 4/30; H01G 4/12; H01G 4/232; H01G 4/248

(52) U.S. Cl. CPC H01G 4/30; H01G 4/12; H01G 4/232; H01G 4/2325; H01G 4/248

(57) ABSTRACT

In an electronic component and a module, a protective layer covers a dielectric layer and a conductive layer in a first capacitor region and a second capacitor region, and also covers a common conductive layer in an intermediate region. That is, the protective layer and the common conductive layer are in direct contact, which improves the adhesion of the protective layer, thereby improving insulation reliability from the outside.

### CROSS-REFERENCE TO RELATED APPLICATIONS

This application is based upon and claims the benefit of priority from Japanese Patent Application No. 2025-25761, filed on 20 February, 2025, the entire contents of which are incorporated herein by reference.

### TECHNICAL FIELD

The present disclosure relates to an electronic component and a module.

### BACKGROUND

PCT international publication WO2022/158340 discloses a circuit board incorporating an electronic component that includes a capacitor structure. In particular, a third embodiment of this document discloses an electronic component in which two capacitor structures are connected in series.

### SUMMARY

In the electronic component according to the related art described above, a protective layer (passivation layer) integrally covers two capacitor structures, thereby insulating the capacitor structures from the outside.

The inventors have conducted repeated research on the protective layer and have newly found a technology that can more reliably achieve insulation from the outside.

According to various aspects of the present disclosure, an electronic component and a module with improved insulation reliability from the outside are provided.

An electronic component according to one aspect of the present disclosure includes a main surface, and when viewed from a side of the main surface, a first capacitor region and a second capacitor region adjacent each other, and an intermediate region interposed between the first capacitor region and the second capacitor region, a common conductive layer extending to straddle the first capacitor region, the second capacitor region, and the intermediate region, a dielectric layer and a conductive layer arranged in order on the common conductive layer in each of the first capacitor region and the second capacitor region, a protective layer integrally covering the dielectric layer and the conductive layer in the first capacitor region, the dielectric layer and the conductive layer in the second capacitor region, and the common conductive layer exposed in the intermediate region when viewed from the side of the main surface, and a pair of external electrodes provided to penetrate the protective layer in portions on the conductive layer of each of the first capacitor region and the second capacitor region and electrically connected to the conductive layer.

Further, a module according to one aspect of the present disclosure includes the above electronic component.

### BRIEF DESCRIPTION OF THE DRAWINGS

FIG. 1 is a plan view showing an electronic component according to an embodiment.

FIG. 2 is a cross-sectional view of the electronic component shown in FIG. 1, taken along line II-II.

FIG. 3 is an enlarged view of a main part of FIG. 2.

FIG. 4 is an enlarged cross-sectional view of a main part showing a form different from that of FIG. 3.

FIG. 5 is an enlarged cross-sectional view of a main part showing a form different from that of FIG. 3.

FIG. 6 is an enlarged cross-sectional view of a main part showing a form different from that of FIG. 3.

FIG. 7 is a cross-sectional view showing an electronic component in a form different from that of FIG. 2.

### DETAILED DESCRIPTION

Hereinafter, embodiments of the present disclosure will be described in detail with reference to the accompanying drawings. In the description of the drawings, the same or corresponding elements are denoted by the same reference numerals, and redundant description is omitted.

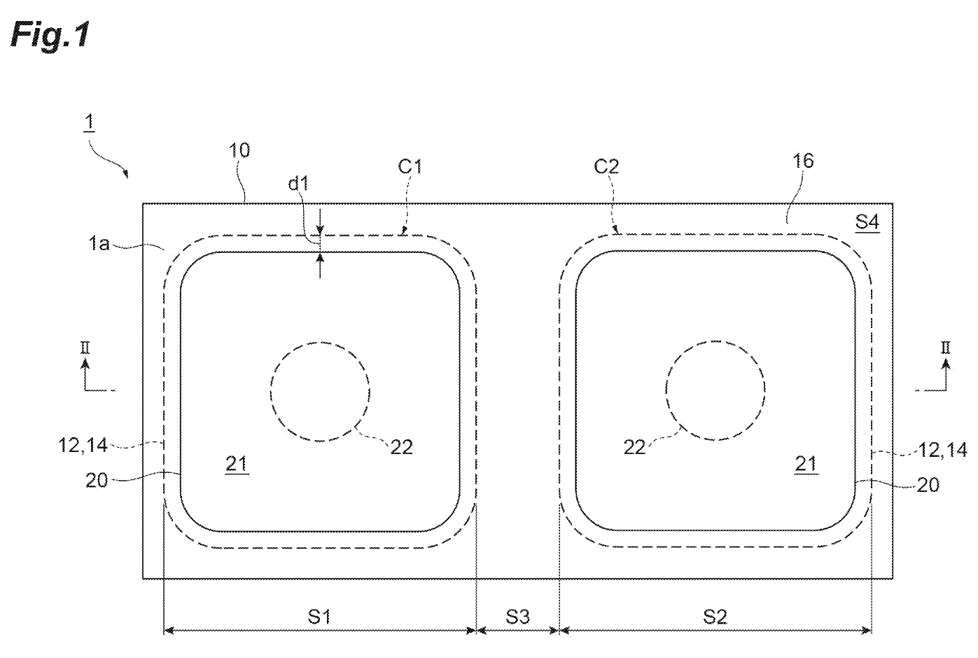

An electronic component 1 according to an embodiment will be described with reference to FIGS. 1 to 3. The electronic component 1 has a laminated structure, and has a main surface 1a and a back surface 1b with respect to its stacking direction. FIG. 1 is a plan view of the electronic component 1 as viewed from the main surface 1a side.

As shown in FIG. 1, the electronic component 1 is provided with a first capacitor region S1 and a second capacitor region S2 as viewed from the main surface 1a side. Capacitor structures C1 and C2 are respectively formed in the first capacitor region S1 and the second capacitor region S2. As viewed from the main surface 1a side, the first capacitor region S1 and the second capacitor region S2 are arranged adjacent each other, separated by a predetermined distance D, and an intermediate region S3 is provided, interposed between the first capacitor region S1 and the second capacitor region S2. That is, as viewed from the main surface 1a side, the first capacitor region S1 and the second capacitor region S2 are indirectly adjacent to each other via the intermediate region S3.

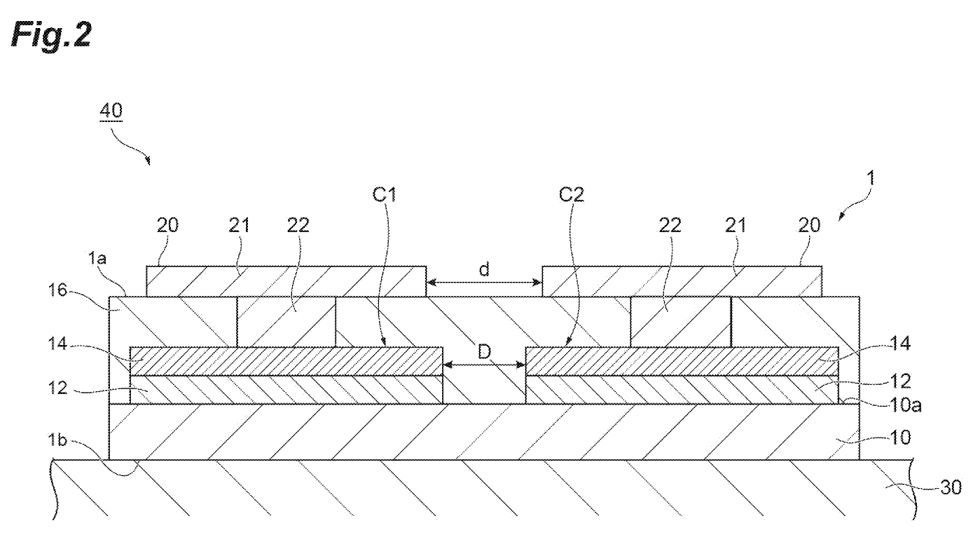

As shown in FIG. 2, both the capacitor structure C1 of the first capacitor region S1 and the capacitor structure C2 of the second capacitor region S2 are configured to include a common conductive layer 10, a dielectric layer 12, and a conductive layer 14.

The common conductive layer 10 is provided over the entire area of the electronic component 1 including the first capacitor region S1, the second capacitor region S2, and the intermediate region S3, as viewed from the main surface 1a side. The common conductive layer 10 extends so as to straddle the first capacitor region S1, the second capacitor region S2, and the intermediate region S3, as viewed from the main surface 1a side. The common conductive layer 10 according to the present embodiment has a shape extending in one direction (that is, a direction in which the first capacitor region S1 and the second capacitor region S2 are arranged) and exhibits a rectangular shape. The rectangular shape in this specification also includes a rectangular shape with rounded corners and a rectangular shape with chamfered corners. Further, the common conductive layer 10 may have a polygonal shape other than a rectangle, or may be circular or elliptical. A dielectric layer 12 and a conductive layer 14 are formed on one main surface 10a (upper surface) of the common conductive layer 10, and the other main surface (lower surface) constitutes the back surface 1b of the electronic component 1. The common conductive layer 10 can be configured with a metal foil, and in the present embodiment, is configured with a Ni foil. For the metal foil, for example, a Ni-based alloy foil, a Cu foil, or a Cu-based alloy foil can be adopted in addition to the Ni foil. By configuring the common conductive layer 10 with a metal foil, sufficient strength and rigidity can be ensured, and it can be handled as a self-supporting substrate. The common conductive layer 10 can be configured with a single layer or multiple layers.

In the first capacitor region S1, a dielectric layer 12 and a conductive layer 14 are stacked in this order on the common conductive layer 10. In the present embodiment, the dielectric layer 12 is directly stacked on the common conductive layer 10, and the conductive layer 14 is directly stacked on the dielectric layer 12. The dielectric layer 12 has a side surface 12a extending parallel to the stacking direction, and the side surface 12a constitutes the outer shape of the dielectric layer 12 when viewed from the main surface 1a side. Similarly, the conductive layer 14 has a side surface 14a extending parallel to the stacking direction, and the side surface 14a constitutes the outer shape of the conductive layer 14 when viewed from the main surface 1a side. In the present embodiment, the side surface 12a of the dielectric layer 12 and the side surface 14a of the conductive layer 14 are flush with each other. Further, in the present embodiment, as viewed from the main surface 1a side, the outer shape of the dielectric layer 12 and the outer shape of the conductive layer 14 generally are identical. As viewed from the main surface 1a side, the outer shape of the dielectric layer 12 and the outer shape of the conductive layer 14 may be identical generally or partially, and the mode of identification includes not only a mode in which both are identical strictly, but also a mode including a deviation amount within ±1% with respect to the total length of the dielectric layer 12 or the total length of the conductive layer 14. Such a deviation includes, for example, a minute difference within a preset range or a manufacturing error.

In the present embodiment, as viewed from the main surface 1a side, both the outer shape of the dielectric layer 12 and the outer shape of the conductive layer 14 exhibit a square shape. The square shape in this specification also includes a square shape with rounded corners and a square shape with chamfered corners. Further, the outer shape of the dielectric layer 12 and the outer shape of the conductive layer 14 may have a polygonal shape other than a square, or may be circular or elliptical. In the present embodiment, as viewed from the main surface 1a side, an outer edge of the first capacitor region S1 is constituted by an outer edge of the capacitor structure C1, and specifically, is constituted by an outer edge of the dielectric layer 12 and an outer edge of the conductive layer 14 that constitute the capacitor structure C1.

The dielectric layer 12 can be configured with, for example, a ceramic dielectric (for example, barium titanate). As a constituent material of the dielectric layer 12, in addition to barium titanate, other dielectrics having a perovskite-type crystal structure or dielectrics having a tungsten bronze-type crystal structure can be adopted. The conductive layer 14 can be configured with a metal layer (for example, a Ni layer). As a constituent material of the conductive layer 14, in addition to Ni, a Ni-based alloy, Cu, or a Cu-based alloy can be adopted. The dielectric layer 12 and the conductive layer 14 can be formed using, for example, a sputtering method.

In the second capacitor region S2, similarly to the first capacitor region S1, a dielectric layer 12 and a conductive layer 14 are stacked in this order on the common conductive layer 10. In the present embodiment, various dimensions (for example, outer dimensions and thickness dimensions) of the dielectric layer 12 and the conductive layer 14 in the second capacitor region S2 are identical to the respective various dimensions of the dielectric layer 12 and the conductive layer 14 in the first capacitor region S1. The mode of identification includes not only a mode in which the dielectric layer 12 and the conductive layer 14 in the first capacitor region S1 and the dielectric layer 12 and the conductive layer 14 in the second capacitor region S2 are identical strictly, but also a mode including, for example, a deviation amount within ±1% with respect to the total length of the dielectric layer 12 and the total length of the conductive layer 14 in the first capacitor region S1. Such a deviation includes, for example, a minute difference within a preset range or a manufacturing error. Further, regarding the constituent materials, the dielectric layer 12 and the conductive layer 14 in the second capacitor region S2 are the same as the dielectric layer 12 and the conductive layer 14 in the first capacitor region S1.

As shown in FIG. 1, the first capacitor region S1 and the second capacitor region S2 are separated from an outer edge of the common conductive layer 10 by a predetermined distance, and an exposed region S4 where the common conductive layer 10 is exposed from the dielectric layer 12 and the conductive layer 14 is formed at the outer edge of the common conductive layer 10. More specifically, both the first capacitor region S1 and the second capacitor region S2 are entirely separated from the outer edge of the common conductive layer 10, and the exposed region S4 completely surrounds the first capacitor region S1 and the second capacitor region S2.

The electronic component 1 includes a protective layer 16 that covers the entire surface as viewed from the main surface 1a side. The protective layer 16 can be configured with, for example, a polyimide-based resin or an epoxy-based resin. In the present embodiment, the protective layer 16 integrally covers the first capacitor region S1 and the second capacitor region S2. At this time, the protective layer 16 integrally covers the dielectric layer 12 and the conductive layer 14 in the first capacitor region S1, and the dielectric layer 12 and the conductive layer 14 in the second capacitor region S2. The protective layer 16 also includes a portion surrounding the first capacitor region S1 and the second capacitor region S2 as viewed from the main surface 1a side, and covers the side surface 12a of the dielectric layer 12 and the side surface 14a of the conductive layer 14 of each of the first capacitor region S1 and the second capacitor region S2.

The protective layer 16 integrally covers the intermediate region S3 in addition to the first capacitor region S1 and the second capacitor region S2, as viewed from the main surface 1a side. In the intermediate region S3, the protective layer 16 covers the common conductive layer 10 exposed from the dielectric layer 12 and the conductive layer 14.

Further, the protective layer 16 also integrally covers an exposed region S4 formed at the outer edge of the common conductive layer 10, in addition to the first capacitor region S1, the second capacitor region S2, and the intermediate region S3, as viewed from the main surface 1a side. In the exposed region S4, the protective layer 16 covers the common conductive layer 10 exposed from the dielectric layer 12 and the conductive layer 14.

In the protective layer 16, an external electrode 20 is provided in each of the first capacitor region S1 and the second capacitor region S2. Specifically, the external electrode 20 is provided through the protective layer 16 in a portion on the conductive layer 14 of each of the first capacitor region S1 and the second capacitor region S2, and is electrically connected to the conductive layer 14. The external electrode 20 can be configured with, for example, Cu. In the present embodiment, each external electrode 20 is configured to include a main body portion 21 located on the protective layer 16, and a connection portion 22 extending from the main body portion 21 through the protective layer 16 to the conductive layer 14.

The main body portion 21 of each external electrode 20 has a substantially square outer shape as viewed from the main surface 1a side. As shown in FIG. 1, the main body portion 21 of each external electrode 20 is designed to be slightly smaller than the capacitor structures C1 and C2 as viewed from the main surface 1a side, and outer edges of the dielectric layer 12 and the conductive layer 14 are exposed from the main body portion 21. Therefore, as shown in FIG. 2, a separation distance d between the main body portion 21 of the external electrode 20 in the first capacitor region S1 and the main body portion 21 of the external electrode 20 in the second capacitor region S2 is longer than a separation distance D between the dielectric layer 12 and the conductive layer 14 of the capacitor structure C1 in the first capacitor region S1 and the dielectric layer 12 and the conductive layer 14 of the capacitor structure C2 in the second capacitor region S2. The separation distance D between the capacitor structure C1 in the first capacitor region S1 and the capacitor structure C2 in the second capacitor region S2 can be designed to be relatively long, and for example, can be designed to be longer than a distance d1 between an outer edge of the external electrode 20 and outer edges of the capacitor structures C1 and C2 as viewed from the main surface 1a side.

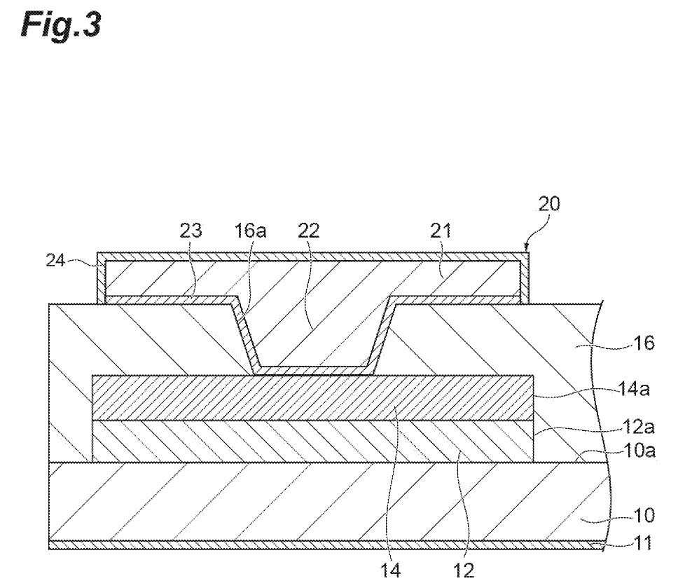

As shown in FIG. 3, the main body portion 21 of each external electrode 20 can include a surface layer 24. The surface layer 24 can be configured with a single layer or multiple layers, and the outermost layer can be configured with a material containing Au as a main component. For example, when the surface layer 24 is configured with three layers, it can be a combination of an Au plating layer, a Pd plating layer, and a Ni plating layer arranged in order from the surface side. By configuring the surface layer 24 of the main body portion 21 of the external electrode 20 with a material containing Au as a main component, it is possible to reliably connect, for example, to a bonding wire connected to the external electrode 20.

The connection portion 22 of each external electrode 20 has a substantially perfect circular outer shape as viewed from the main surface 1a side. A diameter of the connection portion 22 is designed to be narrower than a width of the main body portion 21 as viewed from the main surface 1a side. By designing the connection portion 22 to be narrow in this way, a sufficient contact area between the protective layer 16 and the conductive layer 14 can be ensured, and an improvement in adhesion between the protective layer 16 and the conductive layer 14 is achieved. Each connection portion 22 is located at the center of the first capacitor region S1 and the second capacitor region S2 as viewed from the main surface 1a side, and is connected to the conductive layer 14 at a center position of the conductive layer 14.

In the present embodiment, as shown in FIG. 3, a side surface 16a of the protective layer 16 is inclined with respect to the stacking direction. In this case, a cross-sectional dimension of each connection portion 22 in a cross-section orthogonal to the stacking direction gradually decreases with distance from the main body portion 21, and the width gradually narrows in the cross-section shown in FIG. 3. Such an inclination of the side surface 16a of the protective layer 16 can be formed during patterning of the protective layer 16 (for example, dry etching to form a through-hole in which the connection portion 22 is provided). Since the side surface 16a of the protective layer 16 is inclined, an area of the side surface 16a is increased compared to a case where it is not inclined, thereby improving the adhesion between the protective layer 16 and the external electrode 20.

Each external electrode 20 can be formed by electrolytic plating. In this case, as shown in FIG. 3, each external electrode 20 includes a seed layer 23 (underlayer) at an interface with the protective layer 16 and the conductive layer 14. The seed layer 23 may be configured with the same material as a metal material (Cu) constituting the external electrode 20, or may be configured with a different material. The seed layer 23 can be configured with a single layer or multiple layers, and for example, in the case of two layers, a combination of a Cr sputtered layer and a Cu sputtered layer can be adopted. For the material of the seed layer 23, a material having relatively high adhesion to the protective layer 16 and the conductive layer 14 is adopted, whereby the external electrode 20 has high adhesion to the protective layer 16 and the conductive layer 14.

As described above, the electronic component 1 includes two capacitor structures C1 and C2, and these capacitor structures C1 and C2 can be used by being connected in parallel. In this case, the back surface 1b of the electronic component 1 serves as a mounting surface to be mounted on an external circuit board 30, the common conductive layer 10 located on the back surface 1b is used as an external terminal, and a module 40 is configured by the electronic component 1 and the circuit board 30. When the common conductive layer 10 is used as an external terminal, as shown in FIG. 3, the common conductive layer 10 can include a surface layer 11 that constitutes the back surface 1b of the electronic component 1. The surface layer 11 can be configured with a single layer or multiple layers, and the outermost layer can be configured with a material containing Au as a main component. For example, when the surface layer 11 is configured with three layers, it can be a combination of an Au plating layer, a Pd plating layer, and a Ni plating layer arranged in order from the surface side. By configuring the surface layer 11 of the common conductive layer 10 with a material containing Au as a main component, it is possible to reliably connect, for example, to the circuit board 30 connected to the common conductive layer 10.

In the above-described electronic component 1 and module 40, the protective layer 16 that covers the dielectric layer 12 and the conductive layer 14 in the first capacitor region S1 and the second capacitor region S2 also covers the common conductive layer 10 in the intermediate region S3. That is, the protective layer 16 and the common conductive layer 10 are in direct contact, which improves the adhesion of the protective layer 16, thereby improving insulation reliability from the outside.

Further, the protective layer 16 also covers the common conductive layer 10 in the exposed region S4, and since the protective layer 16 and the common conductive layer 10 are in direct contact also in the exposed region S4, the adhesion of the protective layer 16 is further improved.

The wider the intermediate region S3 and the exposed region S4 are, the more the adhesion of the protective layer 16 can be improved, and for example, the longer the separation distance D between the dielectric layer 12 and the conductive layer 14 in the first capacitor region S1 and the dielectric layer 12 and the conductive layer 14 in the second capacitor region S2 is, the more the adhesion of the protective layer 16 can be improved.

In the electronic component 1 described above, insulation between the common conductive layer 10 and the conductive layer 14 is achieved by the protective layer 16 located in the same layer as the dielectric layer 12. Further, stray capacitance due to a potential difference between the common conductive layer 10 and the conductive layer 14 may occur in the protective layer 16 located in the same layer as the dielectric layer 12. Therefore, by configuring the protective layer 16 with a material having a relatively low dielectric constant, the stray capacitance can be suppressed.

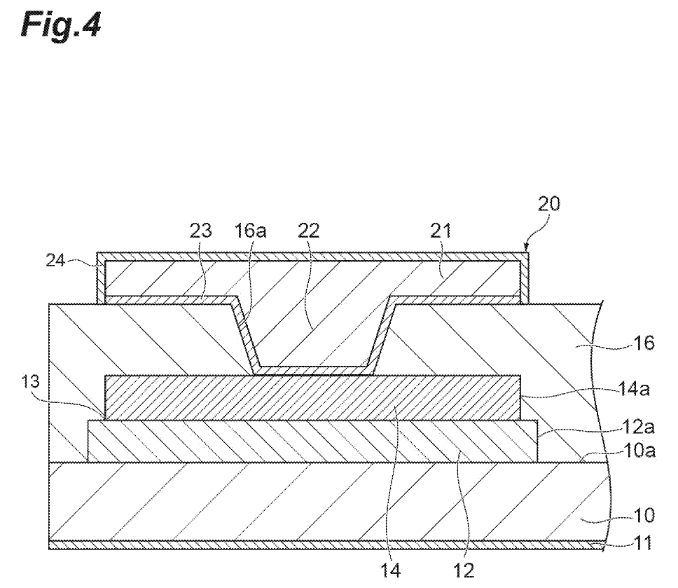

Note that the dielectric layer 12 and the conductive layer 14 constituting the capacitor structures C1 and C2 may have the forms shown in FIGS. 4 to 6, instead of the form shown in FIG. 3.

In the form shown in FIG. 4, both the side surface 12a of the dielectric layer 12 and the side surface 14a of the conductive layer 14 extend parallel to the stacking direction, and the side surface 12a of the dielectric layer 12 protrudes with respect to the side surface 14a of the conductive layer 14. In this case, as viewed from the main surface 1a side, an outer edge of the dielectric layer 12 is located outside an outer edge of the conductive layer 14, and the outer edge of the dielectric layer 12 constitutes an outer edge of the capacitor structures C1 and C2. Further, a step portion 13 is formed between the outer edge of the dielectric layer 12 and the outer edge of the conductive layer 14; by having the side surface 12a of the dielectric layer 12 protrude beyond the side surface 14a of the conductive layer 14 in this way, a creepage distance between the conductive layer 14 and the common conductive layer 10 is extended, thereby suppressing a short circuit between the conductive layers. The step portion 13 may be formed over the entire circumference of the capacitor structures C1 and C2 (that is, the entire circumference of the dielectric layer 12 and the entire circumference of the conductive layer 14) as viewed from the main surface 1a side, or may be formed in a part thereof.

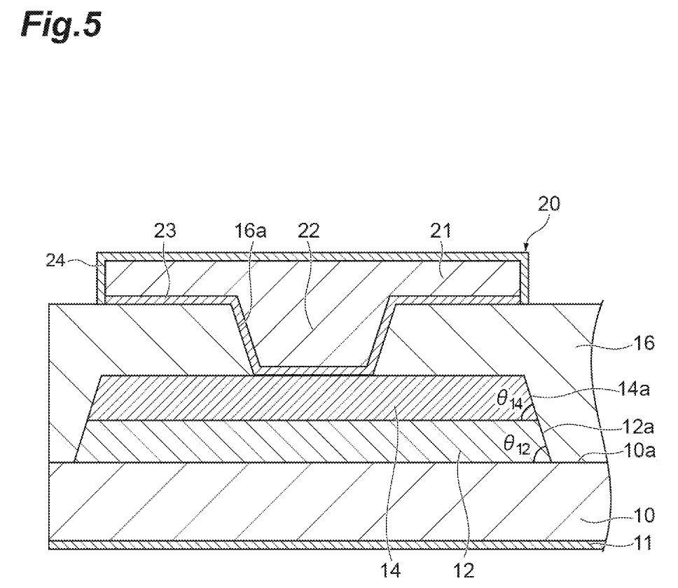

In the form shown in FIG. 5, both the side surface 12a of the dielectric layer 12 and the side surface 14a of the conductive layer 14 are inclined with respect to the stacking direction. The side surface 12a of the dielectric layer 12 is inclined over the entire circumference of the dielectric layer 12, and the side surface 14a of the conductive layer 14 is inclined over the entire circumference of the conductive layer 14. More specifically, an inclination angle θ₁₂ of the side surface 12a of the dielectric layer 12 and an inclination angle θ₁₄ of the side surface 14a of the conductive layer 14 are the same, and the side surface 12a of the dielectric layer 12 and the side surface 14a of the conductive layer 14 are flush with each other. The dielectric layer 12 and the conductive layer 14 have a cross-sectional dimension in a cross-section orthogonal to the stacking direction that gradually increases as they approach the common conductive layer 10, and the width gradually increases in the cross-section shown in FIG. 5. In this case, as viewed from the main surface 1a side, an outer edge of the dielectric layer 12 is located outside an outer edge of the conductive layer 14, and the outer edge of the dielectric layer 12 constitutes an outer edge of the capacitor structures C1 and C2. Such an inclination of the side surface 12a of the dielectric layer 12 and the side surface 14a of the conductive layer 14 can be formed during patterning (for example, dry etching) in a state where the dielectric layer 12 and the conductive layer 14 are overlapped. Since the side surface 12a of the dielectric layer 12 and the side surface 14a of the conductive layer 14 are inclined, an area of the side surface 12a of the dielectric layer 12 and the side surface 14a of the conductive layer 14 is increased compared to a case where they are not inclined, thereby improving the adhesion between the dielectric layer 12 and the conductive layer 14 and the protective layer 16.

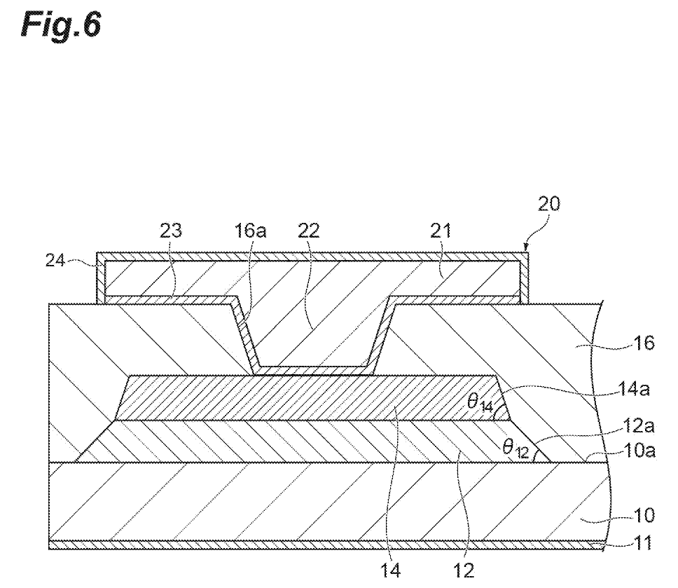

The form shown in FIG. 6 differs from the form shown in FIG. 5 in that an inclination angle θ₁₂ of the side surface 12a of the dielectric layer 12 and an inclination angle θ₁₄ of the side surface 14a of the conductive layer 14 are different. More specifically, the inclination angle θ₁₂ of the side surface 12a of the dielectric layer 12 is larger than the inclination angle θ₁₄ of the side surface 14a of the conductive layer 14. The inclination angle θ₁₂ of the side surface 12a of the dielectric layer 12 and the inclination angle θ₁₄ of the side surface 14a of the conductive layer 14 are mainly determined by etching conditions and layer materials. For example, the inclination angle θ₁₂ of the side surface 12a of the dielectric layer 12 configured with barium titanate is smaller than the inclination angle θ₁₄ of the side surface 14a of the conductive layer 14 configured with Ni, which is more easily etched than barium titanate.

In a cross-section parallel to the stacking direction of the dielectric layer 12 and the conductive layer 14 shown in FIGS. 3 to 6, a length of a contact surface (upper surface in the figures) of the dielectric layer 12 that contacts the conductive layer 14 is equal to or greater than a length of a contact surface of the conductive layer 14 that contacts the dielectric layer 12. In the forms shown in FIGS. 3, 5 and 6, the length of the contact surface of the dielectric layer 12 that contacts the conductive layer 14 is the same as the length of the contact surface of the conductive layer 14 that contacts the dielectric layer 12. In this case, in a cross-section parallel to the stacking direction of the dielectric layer 12 and the conductive layer 14, the entire contact surface of the dielectric layer 12 contacts the conductive layer 14. In the form shown in FIG. 4, the length of the contact surface of the dielectric layer 12 that contacts the conductive layer 14 is greater than the length of the contact surface of the conductive layer 14 that contacts the dielectric layer 12. In this case, in a cross-section parallel to the stacking direction of the dielectric layer 12 and the conductive layer 14, the contact surface of the dielectric layer 12 includes a region that directly contacts the conductive layer 14 and a region that does not directly contact the conductive layer 14. The contact surface of the dielectric layer 12 means a surface including the region in direct contact with the conductive layer 14, and is not limited to the region in direct contact with the conductive layer 14. That is, the contact surface of the dielectric layer 12 may be a surface of the dielectric layer 12 closer to the conductive layer 14, and may include a region that does not directly contact the conductive layer 14. As shown in FIGS. 3 to 6, the dielectric layer 12 and the conductive layer 14 are adjacent to each other. In a configuration where the dielectric layer 12 and the conductive layer 14 are adjacent to each other, the length of the dielectric layer 12 may be equal to or greater than the length of the conductive layer 14.

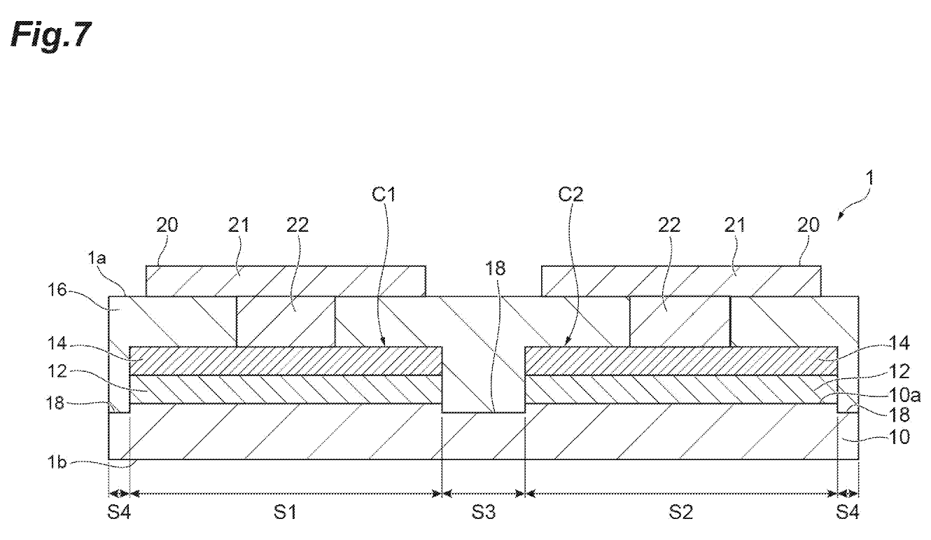

Further, the main surface 10a of the common conductive layer 10 on which the dielectric layer 12 and the conductive layer 14 are stacked may be flat over its entire surface, or may be partially recessed. In the electronic component 1 shown in FIG. 7, a recessed portion 18 is provided in the intermediate region S3 and the exposed region S4 of the main surface 10a of the common conductive layer 10. The recessed portion 18 is a portion that is recessed with respect to the main surface 10a in the first capacitor region S1 and the second capacitor region S2. When the intermediate region S3 is recessed, a contact area between the protective layer 16 and the common conductive layer 10 is increased compared to a case where the intermediate region S3 is not recessed, thereby further improving the adhesion of the protective layer 16. Similarly, when the exposed region S4 is also recessed, the contact area between the protective layer 16 and the common conductive layer 10 is significantly increased, and the adhesion of the protective layer 16 is further improved. Note that a mode may be adopted in which the recessed portion 18 is provided in both the intermediate region S3 and the exposed region S4, or a mode may be adopted in which the recessed portion 18 is provided in only one of the intermediate region S3 and the exposed region S4.

A surface roughness of an inner surface (that is, a bottom surface and a side surface) of the recessed portion 18 may be rougher than a surface roughness of the main surface 10a in the first capacitor region S1 and the second capacitor region S2. In this case, the bonding between the protective layer 16 and the common conductive layer 10 is strengthened, and the adhesion of the protective layer 16 is further improved.

The present disclosure is not limited to the embodiments described above, and can be variously modified. For example, the number of capacitor structures C1 and C2 included in the electronic component 1 is not limited to two, and may be three or more. In this case, the electronic component 1 further includes a capacitor structure similar to the capacitor structures C1 and C2, and three or more capacitor structures are connected in parallel.

What is claimed is:

1. An electronic component, comprising:
a main surface, and when viewed from a side of the main surface, a first capacitor region and a second capacitor region adjacent each other, and an intermediate region interposed between the first capacitor region and the second capacitor region;
a common conductive layer extending to straddle the first capacitor region, the second capacitor region, and the intermediate region;
a dielectric layer and a conductive layer arranged in order on the common conductive layer in each of the first capacitor region and the second capacitor region;
a protective layer integrally covering the dielectric layer and the conductive layer in the first capacitor region, the dielectric layer and the conductive layer in the second capacitor region, and the common conductive layer exposed in the intermediate region when viewed from the side of the main surface; and
a pair of external electrodes provided to penetrate the protective layer in portions on the conductive layer of each of the first capacitor region and the second capacitor region and electrically connected to the conductive layer.

2. The electronic component according to claim 1, wherein when viewed from the main surface side, the common conductive layer has, at an outer edge of the common conductive layer, an exposed region exposed from the dielectric layer and the conductive layer of each of the first capacitor region and the second capacitor region, and
wherein the protective layer also covers the common conductive layer in the exposed region.

3. The electronic component according to claim 1, wherein when viewed from the main surface side, an outer shape of the dielectric layer and an outer shape of the conductive layer of each of the first capacitor region and the second capacitor region are identical.

4. The electronic component according to claim 1, wherein when viewed from the main surface side, an outer edge of the dielectric layer of each of the first capacitor region and the second capacitor region is located outside an outer edge of the conductive layer.

5. The electronic component according to claim 4, wherein a step portion is formed between the outer edge of the dielectric layer and the outer edge of the conductive layer.

6. The electronic component according to claim 4, wherein a side surface of the dielectric layer and a side surface of the conductive layer are inclined with respect to a stacking direction of the dielectric layer and the conductive layer, and a cross-sectional dimension becomes wider with approach to the common conductive layer.

7. The electronic component according to claim 6, wherein an inclination angle of the side surface of the dielectric layer and an inclination angle of the side surface of the conductive layer are the same.

8. The electronic component according to claim 6, wherein an inclination angle of the side surface of the dielectric layer is different from an inclination angle of the side surface of the conductive layer.

9. The electronic component according to claim 8, wherein the inclination angle of the side surface of the dielectric layer is smaller than the inclination angle of the side surface of the conductive layer.

10. The electronic component according to claim 1, wherein in a cross-section parallel to a stacking direction of the dielectric layer and the conductive layer, a length of a contact surface of the dielectric layer contacting the conductive layer is equal to or greater than a length of a contact surface of the conductive layer contacting the dielectric layer.

11. The electronic component according to claim 1, wherein the external electrode has a main body portion located on the protective layer, and a connection portion extending from the main body portion through the protective layer to the conductive layer, and
wherein a width of the connection portion is narrower than a width of the main body portion.

12. The electronic component according to claim 11, wherein the width of the connection portion gradually narrows with distance from the main body portion.

13. The electronic component according to claim 1, wherein the external electrode includes an underlayer at an interface between the protective layer and the conductive layer.

14. The electronic component according to claim 2, wherein the common conductive layer in at least one of the intermediate region and the exposed region has a recessed portion.

15. The electronic component according to claim 14, wherein a surface roughness of the recessed portion is rougher than a surface roughness of the common conductive layer in the first capacitor region and the second capacitor region.

16. The electronic component according to claim 1, wherein a surface of the common conductive layer and a surface of the external electrode are configured with a material containing Au as a main component.

17. The electronic component according to claim 1, wherein the common conductive layer is configured with a metal foil.

18. The electronic component according to claim 1, wherein the conductive layer is configured with Ni.

19. The electronic component according to claim 1, wherein the external electrode is configured with Cu.

20. The electronic component according to claim 1, wherein the electronic component is mounted on an external circuit board at the common conductive layer.

21. A module, comprising the electronic component according to claim 1.
